(19) United States
(12) Patent Application Publication
(10) Pub. No.: US 2018/0284021 A1
(43) Pub. Date: Oct. 4, 2018

(54) ORGANIC-BASED FLUORESCENCE SENSOR WITH LOW BACKGROUND SIGNAL

(71) Applicant: Cambridge Display Technology Limited, Cambridgeshire (GB)

(72) Inventors: Jeremy Burroughes, Cambridge (GB); Richard J. Wilson, Cambridge (GB); Andrew Lee, Cambridge (GB)

(73) Assignee: Cambridge Display Technology Limited, Cambridgeshire (GB)

(21) Appl. No.: 15/764,537

(22) PCT Filed: Sep. 29, 2016
(86) PCT No.: PCT/EP2016/073241

§ 371 Date: Mar. 29, 2018

(30) Foreign Application Priority Data
Sep. 30, 2015 (GB) 1517239.8

(51) Int. Cl. G01N 21/64; G02B 5/22; G02B 5/20

(52) U.S. Cl. CPC G01N 21/645; G01N 21/6428; G01N 2201/0628; G02B 5/208; G02B 5/223

(57) ABSTRACT

Fluorescence-based sensors having favourably low detection limits and high sensitivity are disclosed. The sensors comprise one or more solution processable colour filters that are used together with organic LEDs and photodiodes. The colour filters are used to narrow the wavelength range of the OLED emission and/or to reject any light from reaching the photodiode which is not from analyte fluorescence, thereby enhancing the device sensitivity.

### FIELD OF INVENTION

The present invention relates to fluorescence-based sensors having integral colour filters providing high sensitivity and low detection limits, to arrays comprising the same and to methods of manufacturing the same.

### BACKGROUND OF THE INVENTION

As they inherently exhibit an improved sensitivity over absorption detection techniques, fluorescence detection systems have become important analytical tools in a large number of technical fields, such as e.g. biology, clinical diagnostics, cellular research, food and environmental research (e.g. agricultural analysis).

Organic fluorescence sensors, which usually comprise an organic light-emitting diode (OLED) for emitting an excitation light signal to a fluorophore analyte and a photodiode for detecting the light signal emitted by the analyte, function according to the following principle: A narrow band excitation light is emitted by the OLED. This emission overlaps with the absorption band of a fluorophore, which is either the analyte being sensed or a label attached to the analyte. The fluorophore absorbs photons and is electrically excited, before vibrationally relaxing and then re-emitting a photon at a higher wavelength to return to the electrical ground state. This higher wavelength emission is detected by an organic photodiode and the current produced is used to calculate the concentration of the analyte.

In the recent years, many efforts have been made to improve the portability and applicability of fluorescence-based sensor systems, particularly in view of the high demand in point-of-care and in-the-field applications (see EP 1 582 598 A1, for example).

In order to be economically feasible in these uses, the provision of solution processable organic based fluorescent biosensors is desirable.

In this regard, WO 02/42747 A1 discloses a microfabricated detection system, wherein the light-emitting diode and/or the detector photocells are deposited as a multi-layered structure on a surface of a substrate chip.

In WO 2005/015173 A1, an integrally built up sensor comprising an OLED and a photodiode is disclosed.

WO 2009/013491 A1 discloses compact fluorescence-based sensors configured in an in-line geometry, wherein the light source, sample and detector substantially share a common optical axis

However, the detection limit of such miniaturized devices, which is determined by the signal to noise ratio, has still room for improvement. Since photodiodes exhibit a relatively broadband response, any excitation light that is not absorbed but transmitted by the analyte will also reach the photodiode and give rise to a false positive reading.

Colour filters have been proposed to prevent stray excitation light from reaching the detector and obscuring the weak fluorescence signal. For example, Lee et al., Biosensors 2013, 3, 360-373 disclose the use of plastic or glass filters to increase the signal to noise ratio. However, such filters have the disadvantage that they are unsuitable for the production of a miniaturized, closely spaced array device. In addition, for fluorophore samples having a small Stokes shift (i.e. small difference between positions of the band maxima of the absorption and emission spectra of the same electronic transition) such filters are conventionally replaced by costly interference filters. Beside of the high costs involved with their use, interference filters have the disadvantage that their function is highly dependent on the angle of incident light, which typically results in different cut-off wavelengths for different angles of incident light, thereby limiting their applicability to specific sensor geometries.

Accordingly, the provision of small-size fluorescence-based sensors that may be produced at low costs, allow the applicability on a large number of geometries, and offer a favourably high sensitivity and low detection limit. Fabrication into arrays is also facilitated.

### SUMMARY OF THE INVENTION

The present invention solves this object with the subject matter of the claims as defined herein.

Generally speaking, in one aspect the present invention provides a fluorescence-based sensor comprising: an organic light-emitting diode for emitting an excitation light signal to a fluorophore analyte, an organic photodiode for detecting the light signal emitted by the analyte, and at least one integral colour filter which is arranged between the organic light-emitting diode and organic photodiode and which has been deposited by solution processing.

In a preferred aspect, the present invention provides a fluorescence-based sensor according to the definition above, wherein the at least one integral colour filter is positioned between the organic light-emitting diode and the fluorophore analyte and configured to narrow the wavelength band of the excitation light signal emitted by the organic-light emitting device, and/or wherein the at least one integral colour filter is positioned between the fluorophore analyte and the organic photodiode and configured to block the excitation light signal transmitted by the fluorophore analyte.

In a further preferred aspect, the present invention provides a fluorescence-based sensor according to the definitions above, wherein the sensor comprises: a first integral colour filter positioned between the organic light-emitting diode and the fluorophore analyte and configured to narrow the wavelength band of the excitation light signal emitted by the organic-light emitting diode; a second integral colour filter positioned between the fluorophore analyte and the organic photodiode and configured to block the excitation light signal transmitted by the fluorophore analyte; and a third integral colour filter placed between the first integral colour filter and the analyte and configured to narrow the wavelength band of the light signal transmitted by the first integral colour filter the first, second and third integral colour filters being deposited by solution processing.

In another preferred aspect, the present invention provides a fluorescence-based sensor according to the definitions above, wherein the organic light-emitting device is an organic light-emitting diode having a microcavity structure.

Moreover, an aspect of the present invention is a sensor array comprising a plurality of fluorescence-based sensors according to the definitions above.

In addition, the present invention relates to a method of fabricating a fluorescence-based sensor in accordance to the definitions above.

Accordingly, there is provided an improved sensor system for detection of markers in a sample by fluorescence techniques that offers high sensitivity and low detection limits and which sufficiently compact to enable use for point-of-care or in-the-field applications. Furthermore, the system is low cost.

The advantages of the present invention will be further explained in detail in the section below and further advantages will become apparent to the skilled artisan upon consideration of the invention disclosure.

### BRIEF DESCRIPTION OF THE DRAWINGS

FIG. 1 shows the absorption/emission bands of a red fluorophore relative to the OLED emission spectrum.

FIG. 2 illustrates an exemplary sensor configuration according to the invention using an OLED emitting blue light and a red fluorophore.

FIG. 3 shows absorption spectra for the blue filter Dybright™ SOB 209 and the red filter Dybright™ SOR 835.

FIG. 4 shows the emission spectra of an exemplary non-filtered and filtered blue OLED and an absorption spectrum of an exemplary red fluorophore.

FIG. 5 shows the emission spectra of an exemplary non-filtered and filtered blue OLED and a transmission spectrum of an exemplary red filter.

FIG. 6 shows the emission of an exemplary red fluorophore in relation to the transmission spectrum of an exemplary red filter.

FIG. 7 shows the influence of filters on the spectrometer counts detected at the organic photodiode.

FIG. 8 shows the transmission spectra of exemplary color filters and illustrates the effect of combining two integral colour filters between the OLED and the analyte.

### DETAILED DESCRIPTION OF THE INVENTION

For a more complete understanding of the present invention, reference is now made to the following description of the illustrative embodiments thereof:

In general, the fluorescence-based sensor in accordance to the present invention comprises an organic light-emitting diode for emitting an excitation light signal to a fluorophore analyte, an organic photodiode for detecting the light signal emitted by the analyte, and at least one integral colour filter which is arranged between the organic light-emitting diode and organic photodiode and which has been deposited by solution processing.

The wording integral colour filter as used herein is understood to mean that the colour filter is provided directly on another part of the sensor, without manufacturing the sensor separately and using the same for the assembly of the sensor system.

Solution processing, as used herein, includes e.g. ink-jetting, inkjet spin coating, gravure coating, micro-pen coating, nano-fountain pen coating, dip-pen coating, screen printing, spray coating, slide coating, slot coating, curtain coating, dip coating, and combinations thereof. Preferably, solution processing involves ink-jetting and/or spin coating.

The thickness of the integral colour filter is not critical and is preferably 10 μm or less, more preferably between 1 and 10 μm.

Advantageously, the fluorescence-based sensor according to the present invention is solution processable. The use of solution deposition technology advantageously allows the patterning of many sensors on one substrate with different colour filters. In this way individual sensors can be configured to analyse different analytes. Accordingly, it is possible to manufacture arrays of sensors which are able to screen a single sample for multiple compounds in one pass. Moreover, it is possible to easily adjust the compositions (e.g. dye or pigment concentration) to tune the integral colour filter to a particular OLED and/or organic photodiode and thereby improve performance.

Also, unlike interference filters, solution processable filters work by an absorptive process and exhibit a similar absorption independent of the angle at which incident light enters the filter. Thus, solution processable filters are useful in a wide range of sensor geometries and where light is being collected from a larger angular source.

In a preferred embodiment, the integral colour filter is prepared by depositing a cross-linkable colour filter composition onto the substrate by a solution processing technique, and cross-linking the composition to form the integral colour filter. More preferably, the cross-linkable composition comprises a polymer and a pigment or a dye, and optionally a monomer, a photoinitiator, and/or a binder. Advantageously, the use of cross-linkable compositions allows the colour filter to be deposited under other organic layers, while photo patterning of the colour filter may be easily achieved, thereby offering wide possibilities to manufacture sensor arrays. The method of cross-linking is not particularly limited and may be suitably adapted to the used cross-linking mechanism. As examples, a treatment under elevated temperatures or UV-treatment may be mentioned.

In an alternatively preferred embodiment, the integral colour filter may be prepared without cross-linking by depositing a pigment or dye (optionally with a polymer) in a solvent which does not solve any material of the layer on which the solution is deposited. The concept of such orthogonal solvents also allows to stack multiple integral filters onto each other. For example, an integral colour filter comprising a water-soluble dye or pigment in aqueous solution may be deposited on top of another integral colour filter which has been deposited previously by using a dye or pigment in organic solvent.

In terms of compactness, it is preferable that the fluorescence-based sensor exhibits an in-line geometry, wherein the organic light-emitting diode, the fluorophore analyte, the organic photodioide and the at least one integral colour filter substantially share a common optical axis.

The fluorophore analyte is not particularly limited as long as it is capable of re-emitting light upon light excitation and may be the target substance to be analyzed (if the target substance is a fluorophore) or a target substance to which a fluorophore label serving as a marker is attached. Moreover, the fluorphore analyte may be in solid phase or in liquid phase.

The organic photodiode is a broadband photodetector based on organic semiconductors.

The organic light-emitting diode (OLED) is not particularly limited as long as it is capable of emitting light signal causing the excitation of fluorophore analyte. The OLED may be based on a small molecule emitter or a light-emitting polymer and may exhibit a multi-layered structure.

The at least one integral colour filter may be placed in one or more positions in the sensor configuration. With regard to the position of, the present inventors identified two preferable positions for improving the signal to noise ratio in fluorescence sensors, which will be discussed in the following:

Narrow band excitation light emitted by an OLED typically has a spectral width of about 100 nm (full-width half maximum). This emission overlaps with the absorption of a fluorophore, which is either the analyte being sensed or a label attached to the analyte. The fluorophore absorbs light and is electrically excited, before vibrationally relaxing and then re-emitting a photon at a higher wavelength to return to the electrical ground state.

This higher wavelength emission is detected by an organic photodiode and the current produced is used to calculate the concentration of the analyte. As the photodiode has a relatively broadband response, any excitation light that is not absorbed but transmitted by the fluorophore will also reach the photodiode and give rise to a false positive reading, which is generally observed as a small “tail” in the spectrum but can be intense enough to give an appreciable false signal when measuring emission from very weak or low concentration fluorophores.

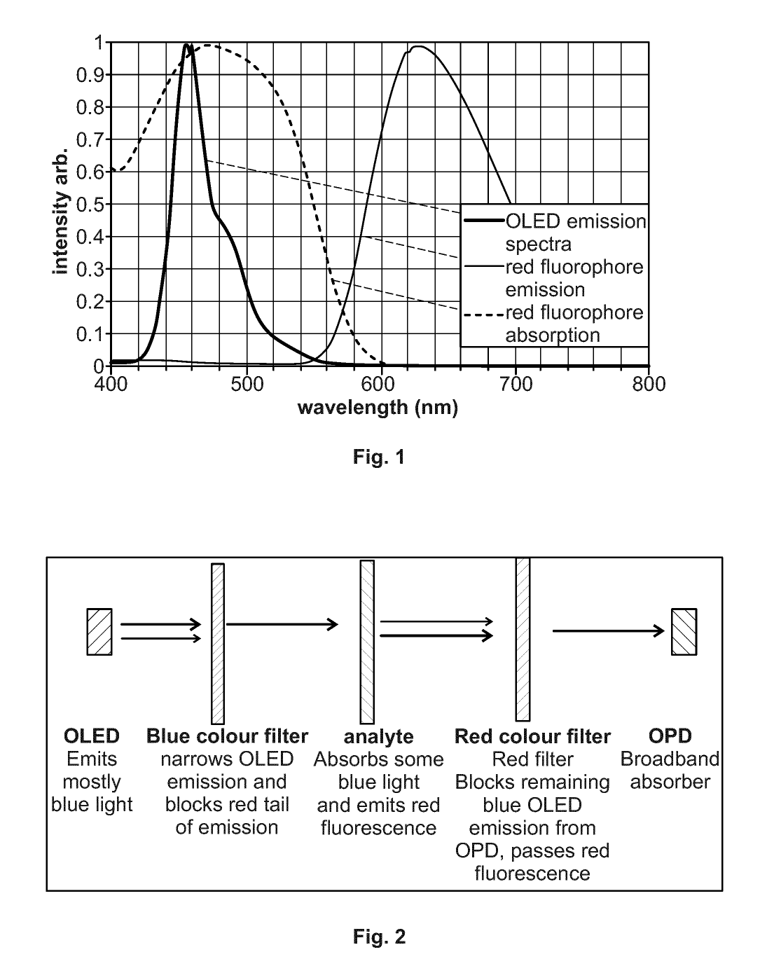

An exemplary spectrum is shown in FIG. 1, wherein the absorption/emission bands of a red fluorophore are shown relative to the OLED excitation light. Herein the OLED emits blue light between about 400 to 500 nm.

In a preferred embodiment of the present invention, the at least one integral colour filter is positioned between the organic light-emitting diode and the fluorophore analyte and configured to narrow the wavelength band of the excitation light signal emitted by the organic-light emitting device. In other words, in this configuration the integral color filter has the effect that the difference between the wavelength limits of the spectral distribution of the light signal exiting the filter is smaller than the difference between the wavelength limits of the spectral distribution of the excitation light. Thus, the background signal may be effectively suppressed, providing enhanced signal to noise ratio and sensitivity.

In addition or alternatively to the use of a integral colour filter at a position between the organic light-emitting diode, it may be preferable that the OLED is included in a microcavity. Cavity tuning of OLEDs may be used to narrow the emission band of excitation light. In case the OLED comprises a printed cathode, cavity tuning becomes more challenging due to the reduced Q-factor of the printed cathode. In this case, it may be preferable to use the integral colour filter at a position between the organic light-emitting diode. Exemplary methods for the preparation of cavity-tuned OLEDs are disclosed in WO 2002/042747 A1, WO 2011/06306 A2, or WO 2005/071770 A2, for example.

In some cases, the absorption band of the fluorophore is too narrow to absorb all excitation light emitted by the OLED, so that excitation light is transmitted by the fluorophore and causes a false reading at the organic photodiode.

Thus, in a preferred embodiment of the present invention, the at least one integral colour filter is positioned between the fluorophore analyte and the organic photodiode and configured to block the excitation light signal transmitted by the fluorophore analyte. In other words, in this configuration the integral color filter has the effect that the intensity of the signal at wavelength band in the spectral distribution of the light signal exiting the fluorophore and not attributed to the fluorescence signal is reduced. Thus, the background signal may be effectively suppressed, providing enhanced signal to noise ratio and sensitivity.

Preferably, the fluorescence-based sensor according to the present invention comprises: a first integral colour filter positioned between the organic light-emitting diode and the fluorophore analyte and configured to narrow the wavelength band of the excitation light signal emitted by the organic-light emitting diode, and a second integral colour filter positioned between the fluorophore analyte and the organic photodiode and configured to block the excitation light signal transmitted by the fluorophore analyte, the first and second integral colour filters being deposited by solution processing. With such a configuration, the signal to noise ratio and sensitivity may be effectively enhanced.

The function of such a configuration is illustrated by FIG. 2, using an OLED emitting blue light and a red fluorophore as examples. Herein, a blue colour filter is used as the first integral filter positioned between the organic light-emitting diode and the fluorophore analyte, and a red colour filter is used as a second integral colour filter positioned between the fluorophore analyte and the organic photodiode.

In a further preferred embodiment the fluorescence-based sensor according to the present invention comprises: a first integral colour filter positioned between the organic light-emitting diode and the fluorophore analyte and configured to narrow the wavelength band of the excitation light signal emitted by the organic-light emitting diode, a second integral colour filter positioned between the fluorophore analyte and the organic photodiode and configured to block the excitation light signal transmitted by the fluorophore analyte, and a third integral colour filter placed between the first integral colour filter and the analyte and configured to narrow the wavelength band of the light signal transmitted by the first integral colour filter, wherein the first, second and third integral colour filters being deposited by solution processing. Such a configuration is particularly advantageous if the fluorophore sample exhibits a small Stokes shift (i.e. small difference between positions of the band maxima of the absorption and emission spectra of the same electronic transition), as the third filter further narrows the wavelength band of the light signal transmitted by the first integral colour filter. Accordingly, fluorpohores with small Stokes shift may be sensed without the requiring costly interference filters.

In another embodiment, the present invention relates to a method of fabricating a fluorescence-based sensor comprising an organic light-emitting diode for emitting an excitation light signal to a fluorophore analyte, an organic photodiode for detecting the light signal emitted by the analyte and at least one integral colour filter arranged between the organic light-emitting diode and organic photodiode, the method comprising depositing the at least one integral colour filter by solution processing. Said method allows to easily pattern many sensors on one substrate with different colour filters or to configure individual sensors so as to analyse different analytes.

In a preferred embodiment, the method comprises the steps of depositing a cross-linkable colour filter composition onto the substrate, preferably by ink-jet printing or spin coating, and cross-linking the composition to form the integral colour filter. Said method allows the colour filter to be deposited under other organic layers. Moreover, photo patterning of the colour filter may be easily achieved, thereby offering wide possibilities to manufacture sensor arrays.

### Examples

Fluorescence-based sensors in accordance with the schematic configuration of FIG. 2 have been prepared by using commercially available blue and red colour filter solutions (Dybright™ SOB 209 and Dybright™ SOR 835, both available by Sumitomo Chemical Company, Ltd.). The filter solutions were spun onto the respective surface of the OLED or organic photodiode, depending on the position in which the filters have been placed, and cross-linked by subsequently dry baking the samples at 100° C., irradiating with UV (400 W iron doped arc lamp with main wavelength band of 350 to 400 nm; irradiance: ˜20 mW/cm²) and heat treating at 220° C. for 40 minutes.

An OLED emitting blue light between 400 and 500 nm has been employed.

Fura Red′ (Glycine, N-[2-[(acetyloxy)methoxy]-2-oxoethyl]-N-[5-[2-[2-[bis[2-[(acetyloxy)methoxy]-2-oxoethyl]amino]-5-methylphenoxy]ethoxy]-2-[(5-oxo-2-thioxo-4-imidazolidinylidene)methyl]-6-benzofuranyl]-, (acetyloxy)methyl ester) has been used as fluorophore analyte.

Transmission and absorption spectra of several samples have been measured. The transmission spectra have been obtained by using an Agilent Cary 5000 UV-VIS-NIR spectrophotometer referenced to uncoated glass, whereas the emission spectra have been recorded with a fiber-coupled Ocean Optics USB2000+ spectrometer.

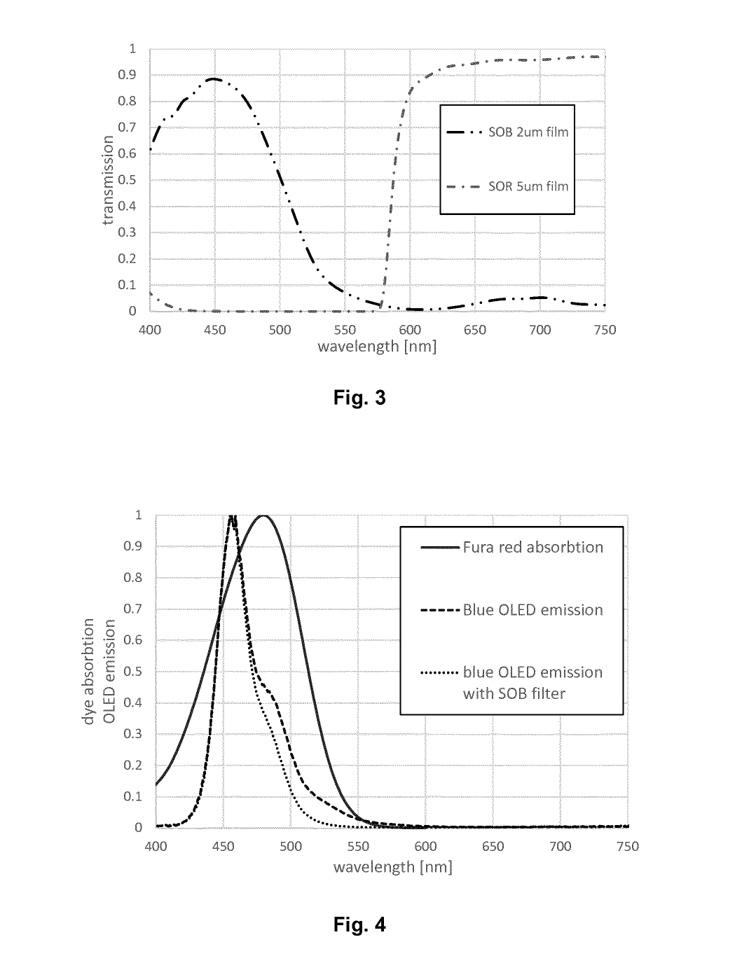

FIG. 3 shows absorption spectra for the blue filter Dybright™ SOB 209 and the red filter Dybright™ SOR 835, spun to thicknesses of 2 μm and 5 μm respectively. As is shown in FIG. 3, the red colour filter used between the analyte and the organic photodiode to reject excitation light cuts off light below 570 nm. The blue colour filter has been used for placement between the OLED and analyte to absorb any emission that might otherwise pass through the red colour filter.

FIG. 4 shows the effect of the blue filter Dybright™ SOB 209 on the emission of the blue OLED and the overlap with the absorption of Fura Red™′.

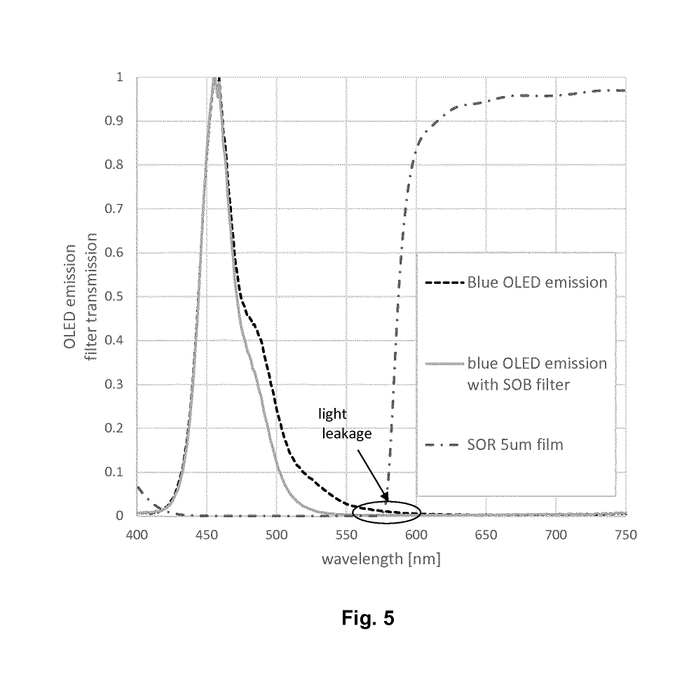

FIG. 5 shows how the narrowed emission from the OLED filtered by the blue filter decreases leakage at around 570 to 580 nm through the red filter Dybright™ SOR 835.

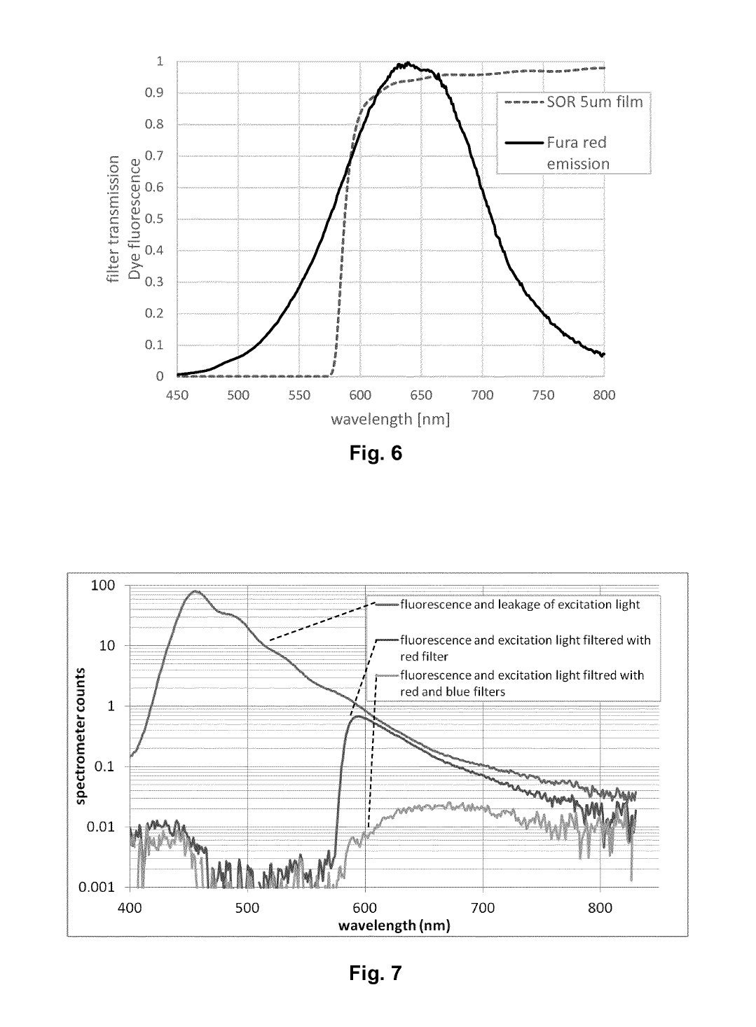

FIG. 6 shows how the Fura Red′ emission is passed by the red filter Dybright™ SOR 835.

FIG. 7 shows the degree to which the filters block excitation light leaking through the sensor, the upper curve shows just the OLED and analyte present, and a large signal reaches the spectrometer. For the middle curve the red colour filter has been added and the combined signal is seen to drop approximately 100 times. For the lower curve the blue colour filter is added as well and the combined signal is seen to drop another 10 times and it can be seen that the majority of the signal is fluorophore emission centred around 650 nm. Altogether the two colour filters have cut the background signal by approximately 1000 times, greatly increasing the signal to noise level and the detection limit.

In a further example, the effect of using a combination of two filters between the OLED and the fluorophore analyte has been studied.

In addition to the blue (Dybright™ SOB 209) and red colour filters (Dybright™ SOR 835), which have been prepared in accordance to the description above, a violet colour filter has been prepared. For this purpose, a solution of 0.1 wt.-% Coomassie Violet R200 (synonym: Acid Violet 17; available from Sigma Aldrich Co. LLC) and 1.4 wt.-% polyvinylpyrrolidone (PVP) has been prepared and left overnight to fully dissolve. The violet filter solution was fixed on the substrate by fitting the substrate with a silicone ring around the area where the violet filter layer is to be deposited, placing the substrate on a hotplate at 90° C., adding 160 μl/cm² solution to the portion within the silicone ring, leaving the solution for approximately 15 min. for the water to evaporate and the substrate to dry, and removing the silicone ring.

The transmittance of each of the violet filter and the blue and red colour filter solutions spun to a thickness of 1000 nm (Dybright™ SOB 209) and 1300 nm (Dybright™ SOR 835) and cross-linked as set out above has been measured by using an Agilent Cary 5000 UV-VIS-NIR spectrophotometer referenced to uncoated glass. In addition, the transmittance of a colour filter set using the blue colour filter as a first integral colour filter and the violet colour filter as a third integral colour filter, wherein the violet colour filter has been deposited on the blue colour filter substrate in accordance to the above description.

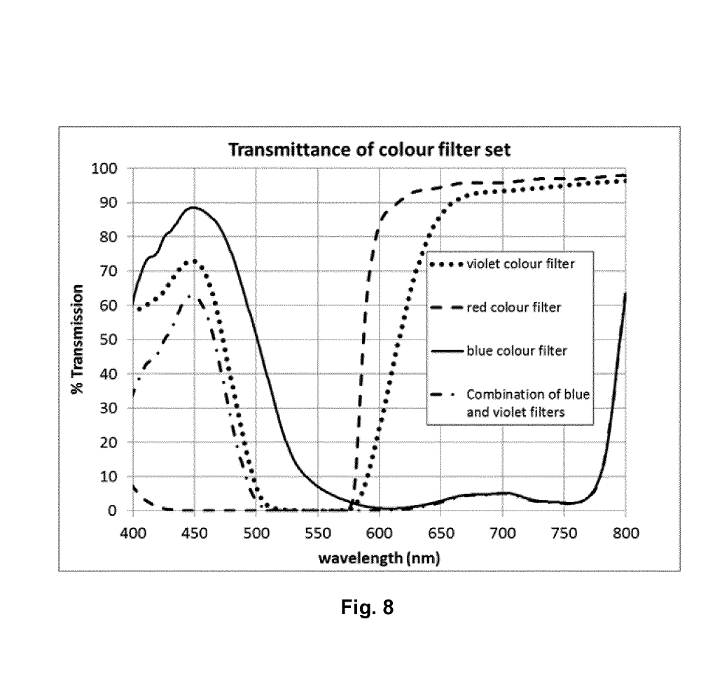

The measured transmission spectra are depicted in FIG. 8, which illustrates how the violet filter further narrows the wavelength band of the light signal transmitted by the blue colour filter.

Accordingly, it is shown that the present invention provides fluorescence-based sensors having a favourably high sensitivity and low detection limits. Moreover, they may be produced at low costs and allow the applicability on a large number of geometries.

Finally, the sensors are small in size and allow for easy fabrication of sensor arrays.

Once given the above disclosure, many other features, modifications, and improvements will become apparent to the skilled artisan.

1. A fluorescence-based sensor comprising: an organic light-emitting diode for emitting an excitation light signal to a fluorophore analyte, an organic photodiode for detecting the light signal emitted by the analyte, and at least one integral color filter which is disposed directly on the organic light-emitting diode or the organic photodiode and which has been deposited by solution processing.

2. The fluorescence-based sensor according to claim 1, wherein the at least one integral color filter is a cross-linked product of a cross-linkable color filter composition deposited by solution processing.

3. The fluorescence-based sensor according to claim 2, wherein the composition comprises a polymer and a pigment or a dye.

4. The fluorescence-based sensor according to claim 1, wherein solution processing comprises an ink-jet-printing or a spin coating method.

5. The fluorescence-based sensor according to claim 1, wherein the at least one integral color filter is disposed directly on the organic light-emitting diode and configured to narrow the wavelength band of the excitation light signal emitted by the organic-light emitting device.

6. The fluorescence-based sensor according to claim 1, wherein the at least one integral color filter disposed directly on the organic photodiode and configured to block the excitation light signal transmitted by the fluorophore analyte.

7. The fluorescence-based sensor according to claim 1, wherein the sensor comprises:
a first integral color filter disposed directly on the organic light-emitting diode and configured to narrow the wavelength band of the excitation light signal emitted by the organic-light emitting diode, and
a second integral color filter disposed directly on the organic photodiode and configured to block the excitation light signal transmitted by the fluorophore analyte,
the first and second integral color filters being deposited by solution processing.

8. The fluorescence-based sensor according to claim 1, wherein the sensor comprises:
a first integral color filter disposed directly on the organic light-emitting diode and configured to narrow the wavelength band of the excitation light signal emitted by the organic-light emitting diode,
a second integral color filter disposed directly on the organic photodiode and configured to block the excitation light signal transmitted by the fluorophore analyte, and
a third integral color filter placed between the first integral color filter and the analyte and configured to narrow the wavelength band of the light signal transmitted by the first integral color filter
the first, second and third integral color filters being deposited by solution processing.

9. The fluorescence-based sensor according to claim 1, wherein the organic light-emitting device is an organic light-emitting diode having a microcavity structure.

10. A sensor array comprising a plurality of fluorescence-based sensors according to claim 1.

11. A method of fabricating a fluorescence-based sensor comprising an organic light-emitting diode for emitting an excitation light signal to a fluorophore analyte, an organic photodiode for detecting the light signal emitted by the analyte and at least one integral color filter disposed directly on the organic light-emitting diode or the organic photodiode, the method comprising depositing the at least one integral color filter by solution processing.

12. The method according to claim 11, comprising the steps of
depositing a cross-linkable color filter composition onto the organic light-emitting diode and/or the organic photodiode, and
cross-linking the composition to form the integral color filter.

13. The method according to claim 12, wherein the cross-linkable color filter composition comprises a polymer and a pigment or a dye.

14. The method according to claim 11, wherein the at least one integral color filter is deposited onto the organic light-emitting diode and configured to narrow the wavelength band of the excitation light signal emitted by the organic-light emitting device, and/or wherein the at least one integral color filter is deposited onto the organic photodiode and configured to block the excitation light signal transmitted by the fluorophore analyte.

15. The method according to claim 11, wherein the organic light-emitting device is an organic light-emitting diode having a microcavity structure.

16. The fluorescence-based sensor according to claim 1, comprising a first color filter disposed directly on the organic light-emitting diode and a second color filter disposed directly on the organic photodiode.

17. The fluorescence-based sensor according to claim 2, wherein the composition comprises a monomer, a photoinitiator, and/or a binder.

18. The method according to claim 12, wherein the cross-linkable color filter composition comprises a monomer, a photoinitiator, and/or a binder.

19. The method according to claim 12, wherein depositing a cross-linkable color filter composition comprises ink-jet printing or spin coating.
